(19) United States
(12) Patent Application Publication
(10) Pub. No.: US 2011/0166875 A1
(43) Pub. Date: Jul. 7, 2011

(54) SYSTEM AND METHOD FOR MANAGING MEDICAL DATA AND FACILITATING REIMBURSEMENT FOR HEALTH CARE

(75) Inventors: Gary A. Hayter, Oakland, CA (US); Charles Wei, Fremont, CA (US); Marc B. Taub, Mountain View, CA (US)

(73) Assignee: ABBOTT DIABETES CARE INC., Alameda, CA (US)

(21) Appl. No.: 12/985,233

(22) Filed: Jan. 5, 2011

Related U.S. Application Data
(60) Provisional application No. 61/292,424, filed on Jan. 5, 2010.

(51) Int. Cl. G06Q 50/00; G06Q 10/00

(52) U.S. Cl. 705/2

(57) ABSTRACT

System and method receive medical data of a patient having a disease afflicted health condition for processing and analysis of that data. Software installed on a health care provider's computer for processing the medical data includes a GUI reimbursement window that informs the HCP of reimbursement possibilities for analysis of the data and counseling of the patient. The reimbursement window also includes hyperlinks and may also include codes for insurance claims. Lists of reimbursement entities, pre-authorization instructions, coding instructions, and contacts may all be included and may be personalized for a particular patient. In one case, a complete bill is created and submitted to an insurance entity. In another, a patient data base is created so that the reimbursement window can inform the HCP of patient analysis frequency, which may affect reimbursement.

### CROSS-REFERENCES TO RELATED APPLICATIONS

This application claims the benefit of U.S. Application No. 61/292,424, filed Jan. 5, 2010, incorporated herein by reference in its entirety.

### BACKGROUND

The present invention relates generally to health care management and, more particularly, to a system and associated method that provide physiological patient data with a program that automatically furnishes reimbursement information.

Diabetes mellitus, or simply, “diabetes,” is an incurable chronic disease. Type 1 diabetics must manage their diabetes by taking insulin to compensate for the rise in blood glucose that follows food consumption. Type 1 diabetes management works to prevent hyperglycemia, or high blood glucose, while especially averting the consequences of hypoglycemia, or low blood glucose, from over-aggressive or incorrect insulin dosing. Poor diabetes management can manifest in acute symptoms, such as loss of consciousness, or through chronic conditions, including cardiovascular disease, retinopathy, neuropathy, and nephropathy. Effective diabetes management requires effort.

Many different ways exist to assist in monitoring and managing one's glucose levels. Health care maintenance systems based on the use of a hand held device are often used. These devices are configured to record patient data such as blood glucose data. Additionally, it is known that such data can be uploaded to a remote server for storage of large quantities of medical data and later access to it by third parties, such as health care providers (HCP). Examples are Google Health and Microsoft HealthVault™. At the remote server location or elsewhere, blood glucose test results can be matched with quantitative information on medication, meals, or other factors, such as exercise.

Medical sensors can generate large quantities of useful information about a physiological parameter or parameters of a patient. That information, when processed, organized, and analyzed in particular ways, can be highly beneficial to a health care provider in examining the patient and recommending treatment. The appropriate calculations, organization, and analyses of that data can assist in forming rapid, useful, and more accurate evaluations of the information, the patient's history, and the patient's present state and health condition.

For example, analyte monitoring and medication delivery devices are commonly used in the treatment of a patient. One or more samples or analytes from the patient's body tissues is sensed and data is accumulated. A monitor, containing a sensor and a processor, may be used to acquire, accumulate, and process that data. Ultimately a report or reports must be produced from that data and an analysis made by a health care provider (HCP). In response to the analysis, one or more medications may be administered to the patient or other course of treatment prescribed, such as exercise and control over the timing, amount, and contents of meals. Administration of the medication may be manual by the patient such as self-injection with a syringe, by another person such as a nurse, or by a powered medication administration device, such as an infusion pump, for automatic or continuous delivery. For example, glucose monitors and insulin pumps are commonly used in the treatment and management of type 1 diabetes mellitus.

In the case of diabetes, a blood glucose monitor (BGM) or continuous glucose monitor (CGM) may be used in obtaining data about the glucose level of a patient. Such sensors detect glucose levels through actual analysis of a drop of blood, or through sensing the composition of interstitial tissue. The patient may have a hand held digital device, such as a personal digital assistant (PDA) that is used to receive and store his or her glucose data. This can occur in a number of ways. In the case where the patient draws a drop of blood onto a test strip that is read by a BGM, the data from the BGM may be communicated to the PDA for storage, processing (such as by adding a date and time stamp), and transfer elsewhere. In one case, the BGM is integrated with the PDA (dedicated device). In another case, the glucose data is communicated to the PDA wirelessly or through wired connection. In both cases of the BGM and CGM, various schemes may be used to get measured patient glucose data onto the PDA. The PDA is programmed to process that data and can provide a useful number representation of a glucose level on the screen of the PDA, and can also be instructed to upload the data to a server that may be remote and which may be accessed through the Internet (cloud computing) or by other means. Conveniently, a computerized report can be used to display such measurements and calculations of the measured glucose together and can be analyzed for use in developing health management recommendations. For example, glucose monitors are programmed to provide recommendations for better blood glucose management in the patient. Such analyses often include trends, extrapolations, predictions, alerts, and others.

The detection of the level of analytes, such as glucose, lactate, oxygen, and the like, in certain individuals is vitally important to their health. Moreover, recording analytics relating thereto, as well as other patient behavior such as activities and meals, and providing this information to health care providers for analysis can provide valuable, life-saving feedback to patients having difficult medical conditions. As discussed above in some detail, the monitoring of glucose is particularly important to individuals with diabetes. Diabetics may need to monitor glucose levels, as well as diet and exercise, to determine when insulin is needed to reduce glucose levels in their bodies or when additional glucose is needed to raise the level of glucose in their bodies. The provision of related analytics to a health care provider may result in a therapy recommendation that may be useful in helping the patient better manage his or her diabetes. Existing data management and analysis tools are available and are further being developed to assist patients and HCPs along these lines.

However, one obstacle to participation in such programs is that obtaining the requisite feedback from a health care provider may be too time consuming and/or difficult for many health care recipients and health care providers to perform. Some health care providers do not have needed programs on their computers to organize and analyze data and do not clearly understand the reimbursement process for such analyses. Consequently, such an analysis may be time consuming and difficult for some doctors. Further, many doctors are also unaware that reimbursement is available from health care companies, patient employers, Medicare, etc., for such an analysis. Moreover, a lack of health care provider interaction in the monitoring process has the potential to drastically undercut the benefits available in existing disease, diabetes, and analyte management systems.

The health insurance industry, companies that pay health insurance premiums, and others that are responsible for health care have recently started to encourage people to improve their health by providing direct health and wellness coaching. They reward people for taking standard health tests, discussing the results with a health advisor and engaging in wellness-enhancing activities. Often the reward is a discount on the employee portion of the health insurance premiums or discounts on other goods and services. It would be of value to further encourage this approach to improving the health of people by facilitating data analysis and cost reimbursement.

Hence, those of skill in the art have recognized that there is a need for systems and methods that provide incentives and facilitate greater participation in wellness-enhancing programs and improvements in disease management. Those skilled in the art have also recognized a need for encouragement to patients to collect and communicate health condition data for analysis by a skill health care professional. Another identified need is the analysis of collected patient data by a health care provider or professional. A further need is for systems and methods that inform health care providers of patient data, reimbursement for analysis of that data, facilitate their involvement in data analysis and conferring with the patient to advise on wellness-enhancing activities and lifestyles, and otherwise encourage feedback, interaction, and reward in disease management. Another identified need is for a system and method devised to provide detailed notification to analysts of the opportunity for reimbursement for performing an analysis of patient data. The present invention fulfills these needs and others.

### SUMMARY OF THE INVENTION

Briefly and in general terms, the present invention is directed to a medical data management system and method to facilitate reimbursement for analysis of the medical data by providing reimbursement information to those that would perform such analysis. In particular, in accordance with method aspects, there is provided a method of managing medical data and facilitating reimbursement for data analysis, the method comprising selecting a program to process medical data, automatically enabling a reimbursement display that includes information relating to reimbursement for analysis of medical data, and selecting the reimbursement display of information and options for viewing. More detailed aspects include enabling the display in a separate interactive window, wherein the window provides specific instructions for obtaining reimbursement.

Yet further more detailed aspects include connecting the reimbursement window to an electronic reimbursement system by which an automated reimbursement process is initiated. Further, enabling the display comprises automatically enabling a display of reimbursement information and reimbursement options for analysis of processed medical data comprising at least one of: linking to secondary websites related to reimbursement, linking to websites containing reimbursement resources, linking to websites containing a form usable for reimbursement, linking to a request for obtaining reimbursement, linking to a web page of a reimbursement entity, creating a customizable superbill for reimbursement for analysis services, creating a bill having relevant reimbursement codes, checking reimbursement codes to confirm correct coding entries, looking up reimbursement coding usage with a lookup tool, automatically updating reimbursement codes, displaying information directed to patient coverage pre-authorization requirement data, displaying information directed to patient pre-authorization process instructions, creating a patient coverage pre-authorization request, displaying information related to evidence needed to justify reimbursement, displaying information directed to workflow support so that a relevant function is provided in the right stages of serving the patient, displaying alarms and notices relating to requirements for further information by a reimbursement entity, and displaying information relating to audit trail records with respect to processing of information for the reimbursement entity.

Other detailed aspects include automatically enabling the display during operation of a medical data processing program, automatically enabling the display as part of uploading medical data, and installing the reimbursement display from a source of the uploaded medical data. Also further comprising uploading medical data from a physiological parameter monitor, and installing the reimbursement display from the physiological parameter monitor. In addition, the method comprises automatically enabling the reimbursement display upon receipt of patient analytics data. Method aspects further include selecting a program to process medical data, automatically enabling a reimbursement display in a separate interactive window of a GUI when processing medical data, the display including information relating to reimbursement for analysis of medical data and instructions for obtaining reimbursement, uploading medical data from a physiological parameter monitor, installing the reimbursement display from the physiological parameter monitor, and selecting the reimbursement display of information and options for viewing.

System aspects in accordance with the invention include a medical data management system to facilitate reimbursement for analysis services on medical data, the analysis performed with a processor and a display, the system comprising a medical monitor configured to sense a physiological parameter relevant to a particular disease-afflicted health condition and to provide medical data representative of the sensed parameter, and a physical medium containing a program configured to program a processor to automatically enable a reimbursement display that includes information relating to reimbursement for analysis of the received medical data, and control a display to present the reimbursement display in a separate window.

Further more detailed system aspects include the program further configured to program the processor to present in the reimbursement display at least one of a link to a secondary website related to reimbursement, a link to a website containing reimbursement resources, a link to a website containing a form usable for reimbursement, a link to a request for obtaining reimbursement, a link to a web page of a reimbursement entity, information directed to patient coverage pre-authorization requirement data, information directed to patient pre-authorization process instructions, information related to evidence needed to justify reimbursement, information directed to workflow support so that a relevant function is provided in the right stages of serving the patient, alarms and notices relating to requirements for further information by a reimbursement entity, information relating to audit trail records with respect to processing of information for the reimbursement entity, and is further configured to program the processor to perform at least one of create a customizable superbill for reimbursement for analysis services, create a bill having relevant reimbursement codes, check reimbursement codes to confirm correct coding entries, look up reimbursement coding usage with a lookup tool, automatically update reimbursement codes, and create a patient coverage pre-authorization request.

Other more detailed system aspects include the program being further configured to program the processor to connect the reimbursement window to an electronic reimbursement system by which an automated reimbursement process is initiated. The program being further configured to program the processor to upload medical data from the medical monitor and install the reimbursement display from the medical monitor, and the medical monitor comprising a glucose sensor configured to sense a glucose level and to provide glucose level signals; and the program is further configured to program the processor to receive the glucose level signals, analyze the received glucose level signals, enable the reimbursement display that includes information relating to reimbursement for the analysis, and present the reimbursement display on the display.

Various features and advantages of the invention will become more apparent by the following detailed description of several embodiments thereof with reference to the attached drawings, of which:

### BRIEF DESCRIPTION OF THE DRAWINGS

FIG. 1 is a block diagram of an exemplary health care system including a health care provider environment, a health care insurance entity, and showing a data network interconnecting all entities;

FIG. 2 is a block diagram of an exemplary health care provider environment consistent with FIG. 1 and showing further details of aspects of embodiments of that environment with certain programming being shown;

FIG. 3 is a flow chart of a method illustrating the use of a separate window on a display to apprise the health care provider of reimbursement information and options;

FIG. 4 is similar to FIG. 3 in that it presents a flow chart of a separate window on a display to apprise the health care provider of reimbursement information and options, but also present the HCP with advice and additional reimbursement resources;

FIG. 5 also presents a method in facilitating reimbursement of medical data analysis showing the operation of interactive software in association with medical data analytics, and a GUI pop-up window showing reimbursement options; and

FIG. 6 shows further method aspects in which an interactive HCP program operates in conjunction with medical data analytics and provides the HCP with information and other reimbursement resources through a pop-up window of a GUI.

### DETAILED DESCRIPTION OF THE PREFERRED EMBODIMENTS

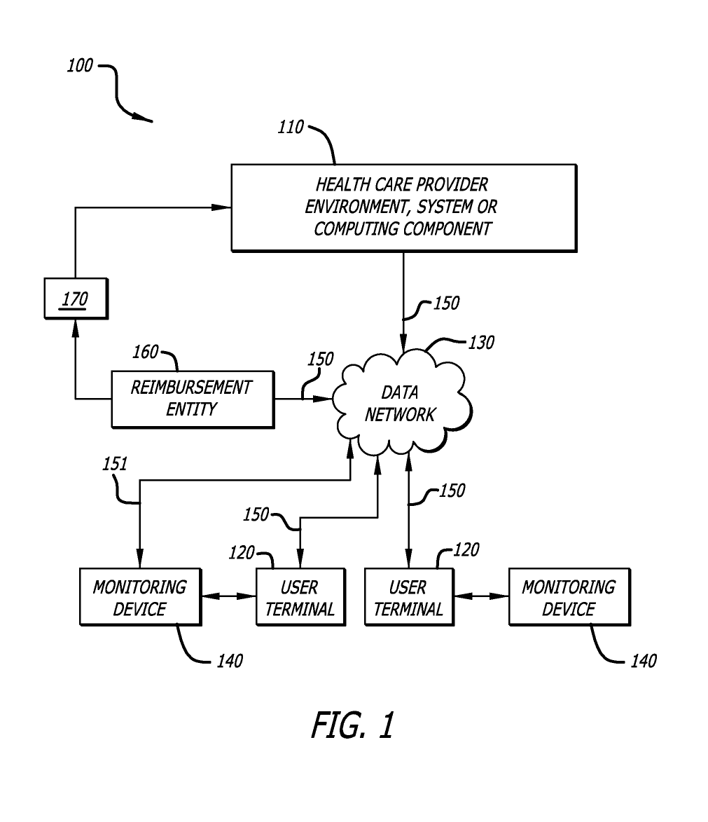

Reference will now be made in detail to embodiments of the invention, as described below and shown in the accompanying drawings. The embodiments set forth in the following description and in the drawings do not represent all embodiments consistent with the claimed invention. Instead, they are merely examples. Referring now to the drawings wherein like reference numerals denote like or corresponding elements among the several views, there in shown in FIG. 1 a block diagram of a system of patient care and health care provider environment with reimbursement features 100. The environment with reimbursement features 100 includes an environment, system, or computing component 110 (HCP environment 110) that is associated with one or more health care providers and is operatively coupled to one or more user terminals 120 (two of which are shown) or other source of patient analytics information via a data network 130. As can be seen from FIG. 1, each of the user terminals 120 may also be configured to be operatively connected to a respective one or more testing or monitoring devices 140. As will be discussed in further detail below, there is also provided a reimbursement entity or computing component 160 operatively coupled to the data network 130 for communication with the HCP environment 110, the user terminals 120, and other components associated with the network 130. Shown also is a monitor device 140 directly connected to the network 130 by wired or wireless connection.

The reimbursement entity 160 provides consideration 170 to the health care providers consistent with aspects of the innovations herein. In some implementations, the reimbursement entity 160 may receive information and instructions from the health care provider environment 110. These information and instructions may take the form of simple instructions for the reimbursement entity to reimburse a healthcare provider with consideration 170, such as money, credit, wellness-promoting or business incentives, etc. Furthermore, such exchange of information and instructions may take the form of interrelated software components that provide reimbursement functionality in the context of automated systems or subsystems that assist the health care providers with the analysis of patient data and even recommendations for treatments or responses thereto. For example, the reimbursement entity 160 may be the same entity as, or in partnership with, the entity that supplies the health care provider software in the health care provide environment 110, and may extend to additional third parties; e.g., service providers who provide reimbursement entities and HCPs with updated reimbursement codes and paperwork. In the latter respect, the reimbursement entity 160 may provide reimbursement paperwork to a HCP having fields pre-populated with information based on patient data analysis, for use by the HCP in submitting the report to a payor. The reimbursement entity 160 or a third party service provider with available and appropriate reimbursement options as well as a wizard program or other guide for the HCP may be used to execute a claim for payment.

In some implementations, the testing or monitoring device 140 may include one or more patient monitoring devices such as a glucose meter (for example, a glucose meter that may have wireless communication capabilities) which is configured to automatically and wirelessly transmit the measured glucose data to the HCP environment 110 via a wireless connection 151 and/or network 130. In this case, a computing component within the HCP environment 110 may be configured to obtain or receive patient data, such as measured glucose data, from the testing or monitoring devices 140 and store the received data in a corresponding user account associated with the devices and patient. In one particular embodiment, a glucose monitor may include a USB port enabling the monitor to be directly connected with the USB port of an HCP computing component for direct transfer of glucose data to the HCP computing component.

With continuing reference to FIG. 1, it can be seen that each of the user terminals 120, the reimbursement entity 160, and the HCP environment 110 are operatively coupled to the data network 130 via links such as data communication links 150. Within the scope of the present invention the data communication link 150 may include wired or wireless communication paths which may be configured for secure, encrypted bi-directional data exchange over the data network 130. In particular, a data communication link 150 in one embodiment may include WiFi data communication, IrDA data communication, infrared data communication, Bluetooth data communication, ZigBee data communication, USB or Firewire cable-based data communication, Ethernet cable-based data communication, and dial up modem data communication.

For example, in some implementations, the user terminals 120 may include one of a personal computer (including a desk top or a laptop computer) or a handheld communication device such as a smart phone (such as a Blackberry™ telephone), other Internet access-enabled mobile telephones, a bi-directional communication-enabled pager, and a communication-enabled personal digital assistant (PDA). In one implementation, the user terminals 120 include an output unit such as a display and/or speakers, an input unit such as a keyboard or a touch-sensitive screen, as well as a controller such as a CPU for performing user instructed procedures at the user terminals 120. Additionally, the user terminal 120 may be also configured to communicate with the testing or monitoring devices 140 via short range RF communication path, an infrared or IrDA communication path, or using Bluetooth communication protocol or other. Additionally, the testing or monitoring device 140 may also be configured to connect to the respective user terminals 120 via a wired connection such as a USB connection, an RS-232 cable connection, or an Ethernet cable connection, or other.

In FIG. 1, the reimbursement entity 160 may be configured to communicate with the HCP environment 110 and the user terminals 120 over the data network 130 using either a wired or wireless secure and encrypted connection. As is generally the case, because the relevant patient and/or reimbursement information may be very sensitive, a high level of security for data communication to and from the reimbursement entity 160 and other parties to such communications may be used, such as an encryption level exceeding 128-key encryption, and the like. Within the scope of the present invention, the reimbursement entity 160 may include one of: a provider of services or supplies to HCPs or patients, a provider of software used by the HCPs and/or patients, a banking institution terminal, a credit card institution terminal, a brokerage institution terminal, one or more service providers that interact with HCP or Patient in providing updated reimbursement information and other resources through the data network 130 or directly to the HCP, and any other financial institution terminal which maintains a financial account of a user with which financial account transactions may be performed.

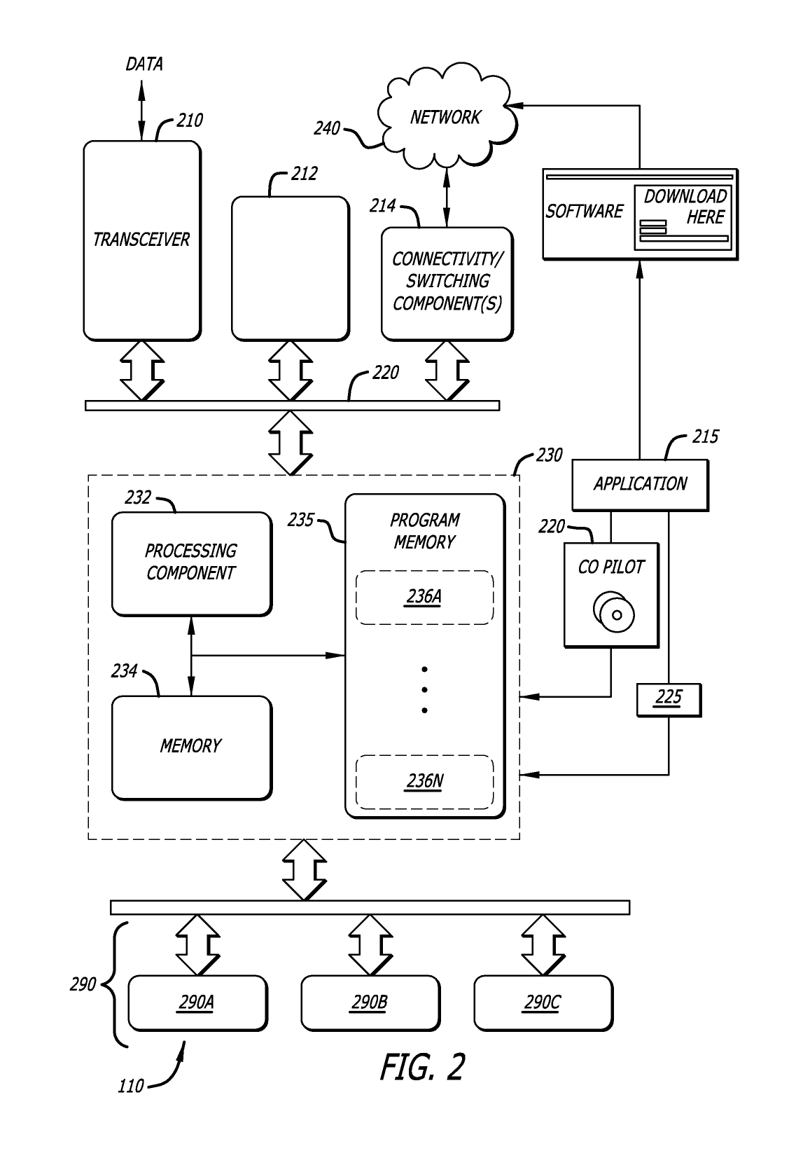

Referring yet again to FIG. 1, the HCP environment 110 in one exemplary implementation may include one or more computing components, such as one comprising a controller operatively coupled to an input-output (I/O) interface unit, a read-only memory (ROM), a random access memory (RAM), and data store(s). In general, in some implementations, the data store(s) may include a server application and an operating system. In this manner, as is set forth in more detail in connection with FIG. 2 below, the controller may be configured to communicate with the user terminals 120 and the reimbursement entity 160 over the data network 110 via the I/O interface unit, under the control of the various processes and routines stored in the ROM, the data store(s), etc., and/or associated with user transmitted requests and information.

According to further implementations, such server applications and operating systems of the data store(s) may be configured to provide a proprietary interface for the users, to execute secured and encrypted data communication over the data network 130. More specifically, the HCP environment 110 may be configured to provide a proprietary Internet-based user interface at a predetermined URL for health care providers to login using a variety of computing platforms. Alternatively or in addition, the data network 130 may include the Internet, wherein the server application(s) and the operating system(s) of the HCP environment 110 are configured to provide a dedicated website for allowing health care providers to securely and easily login using terminals over the data network.

Alternatively or in addition, the data network 130 may include a computing program installed at a user terminal 120 or a local area network accessible by same, wherein the computing program is configured to provide a user interface and database to allow health care providers to upload patient-specific medical data and work with the data within the confines of the computer program.

FIG. 2 illustrates an exemplary configuration of a health care provider (HCP) computing environment 110. A HCP computing component 230 may be implemented as a device configured for communication with other computing components or platforms throughout the overall environment 100 (FIG. 1) and/or the HCP environment 110, and may include a processing component 232, at least one memory component 234 (e.g. RAM, etc.), and a program memory 235 (e.g., ROM, Flash memory, disk or optical drives, CD-ROMs, etc.). Further, the HCP computing component 230 may have one or more of a variety of input/output devices 290, such as a keyboard 290A, mouse 290B, a display 290C, and/or auditory or other human/sensory interactive components.

The HCP computing component 230 may include or be associated with a transceiving component 210 to enable communication via various channels, including transmission and/or receipt of information composed of or including MPEG-encoded digital video and audio data, digital data, software programs, data files, and the like. The HCP computing component 230 may also be associated with other data processing components 212 (e.g., security, encryption/decryption, etc.) and/or additional connectivity components 214 such as routing/switching components (e.g., back channel connection components, etc., such as network cards, routing components, RF receivers, ports, receivers, etc.) giving access to data networks such as network 130 (FIG. 1) to provide connection to components associated with such networks.

Such HCP computing components 230 may have the underlying health care provider application 215 already installed, and/or the systems and methods herein may include providing such an application via computer readable media 220 such as one or more CD-ROMs, via other memory devices 225 including computer readable media, digital media, flash drives, optical drives, etc., or via electronic communication such as wired or wireless transmission, e-mail, download over a network 240 such as the Internet, etc. The HCP computing component 230 may be configured to run an operating system which supports multiple applications. Such operating system is typically a multitasking operating system that enables simultaneous execution of multiple applications. In some implementations, the operating system may utilize a graphical user interface environment that implements the applications or documents in a window-type operating system, such as Microsoft Windows, OS2 by IBM, or Apple Macintosh. Once resident on the HCP computing component 230, such health care provider applications 215 may be utilized as set forth herein, e.g., to facilitate reimbursement of health care providers in the process of handling and/or analyzing patient information, as is discussed in detail below.

In a particular example, a glucose monitor 140 (FIG. 1) is configured to have a USB port for direct communication of stored glucose level data from the monitor 140 to a HCP computing component 230. The monitor 140 also includes an application program for use by or upload to the HCP computing component 230, or both, for viewing the glucose level data on the HCP's computing component 230 and that application program may have components that enable more complex analysis functions with the transferred glucose data. Additionally, the monitor 140 application program or programs uploaded to the HCP computing component 230 also contain an application program for enabling the display of a reimbursement window in which reimbursement information, links, connections, programs for establishing connections and interfacing with reimbursement entities, are placed in operation on the HCP computing component. In one embodiment, the window is interactive. Functionality may include the creation of a patient data base, as is described, and other more complex data, as well as printing and display. A component will also enable storage of the data elsewhere, if so selected. A HCP superbill can also be created by means of this application program. Because this application program is installed on the HCP computing component 230 directly by the monitor 140 that is supplying the medical data, the application program will be designed for operation with the particular data format of the monitor. The HCP will not need to separately obtain a program for use with the monitor and deal with installation and the various other activities that surround such independent programs.

The reimbursement window created by the foregoing application program is automatically enabled upon installation and can be programmed to automatically appear as soon as the monitor 140 is connected with the HCP computing component 230, or can be programmed to automatically appear when data transfer begins from the monitor 140, or can be programmed to automatically appear when the HCP begins performing any data analysis, or can be simply an icon on the main window, the manual selection of which opens the reimbursement window. Other arrangements are possible. In this embodiment, the reimbursement window is a separate window from others. It may be closed in the standard way, such as clicking on either corner at the top of the window, or by other means.

The HCP computing component 230 may be used to implement a computer-based data management system known as the CoPilot™ Health Management System (CoPilot™ system) from Abbott Diabetes Care Inc., Alameda, Calif. The CoPilot™ system is a personal computer (PC or portable or handheld appliance)-based software application that permits people with diabetes, their health care provider team, and other caregivers to upload data from FreeStyle™ and Precision Xtra™ blood glucose monitoring systems (and generally from several other commercially available blood glucose meters and insulin pumps) into the CoPilot™ system application.

The CoPilot™ system provides an accessory to a blood glucose monitoring (BGM) system such as the FreeStyle and Precision Xtra blood glucose monitoring systems and other commercially available blood glucose meters and insulin pumps. The application provides graphs and other software tools for people with diabetes and their health care providers to help evaluate and analyze medical information such as glucose readings, carbohydrate intake, insulin dosage, exercise, and other diabetes-related factors uploaded from devices or manually entered into the system. The system can help identify trends that can be used to educate persons with diabetes to improve their glucose control, for example. According to aspects in accordance with the invention, and as described further hereinbelow with respect to FIGS. 4-6, such a software application can be configured to employ various means to provide HCPs with reimbursement information or options.

Additional detailed description of the above-described PC-based software application for healthcare management and its various features and functionality are provided in U.S. patent application Ser. No. 11/146,897 filed Jun. 6, 2005 entitled “Diabetes Care Report generation Architecture and Data Management System,” assigned to the Assignee of the present application and incorporated herein in its entirety.

The application layer component 215 may also track the transmission and receipt of information among any two or more of the HCP, patient, reimbursement entity, and other service providers with appropriate time stamp and audit trail capability. Since some messages to and from these entities could be time sensitive, delivery notification and alerts for senders when messages are not received or read are important functions to facilitate interaction among these entities.

Continuing to refer to FIG. 2, the memory 234 and/or other data store(s) of the HCP computing component 230 in some implementations may be configured to store data and information related to the patients and/or patient accounts such as, but not limited to, identification, user contact information such as telephone and/or facsimile numbers, email address, billing and shipping addresses, user account profile information such as replenishment level information, seasonality or periodicity of user use of the testing or monitoring device, user financial account information (for example, a bank routing number and bank account number in the case of a banking institution), and user testing or monitoring device data information such as the user, strip order history, health-related monitoring data such as previously measured glucose levels, user specific basal profile information, bolus determination information, insulin sensitivity, trend information determined based on the measured glucose levels (e.g., determined by the controller, etc.), and additional healthcare provider information for the user such as contact information for the patient's other physician(s), hospital(s), nursing facilities, etc.

In addition, the memory 234 may also be configured to provide archival and audit trail data for any interactions between any two or more of the HCP, patient, reimbursement entity, and other service providers in order to provide comprehensive review capability to the HCP or Patient.

Furthermore, since the memories 234 and 235 may contain patient financial and medical information that is subject to privacy protections under laws such as HIPPA or patient privacy expectations, they are preferably hosted on a secure server and memory storage system wherein access is restricted only to privileged users.

The HCP computing component 230 also typically includes the program memory 235 which includes a variety of program modules 236A-236N, such as communication components that enable sessions, authorize transmissions, etc. between the HCP computing component 230 and other elements of the overall environment 100, including software modules such as encryption/decryption, key handling, hashing, signing, authentication, CAPI, CSPs, etc., implemented via dynamic link libraries and/or other existing techniques.

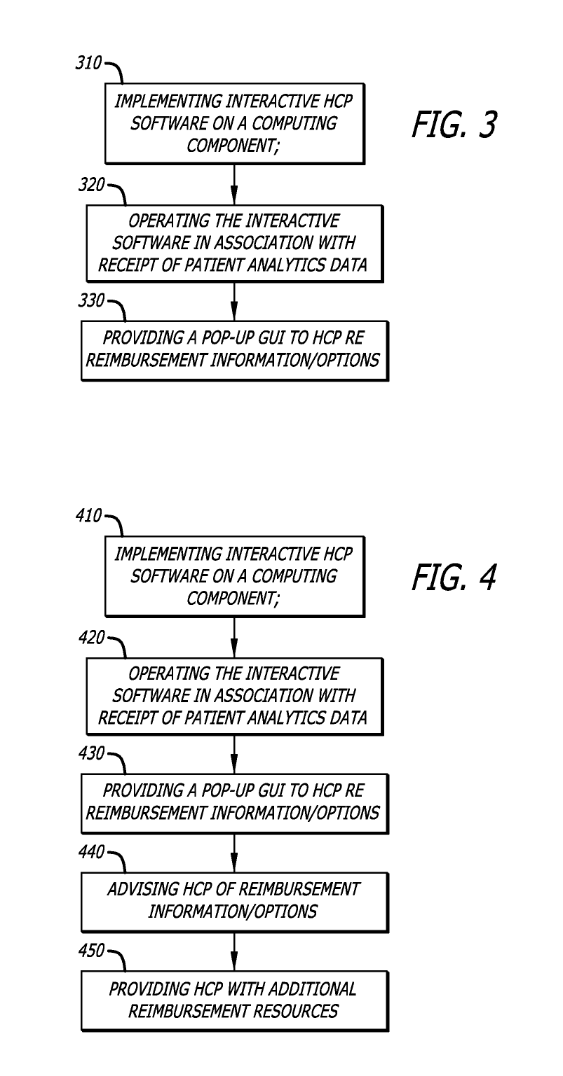

FIG. 3 is a flow chart illustrating an embodiment of a method in accordance with aspects of the invention in which patient medical data is managed and reimbursement for this management and treatment are facilitated. The method comprises implementing an interactive health care provider (HCP) program (software, in this embodiment) on a computing component 310. That HCP program is operated in receiving patient medical data for management and processing 320. The program may be operated via a software download or installation utility. During operation of the program 320, a graphical user interface (“GUI”) window is made available either through automatic pop-up, manual selection, or otherwise, and advises the HCP of reimbursement information and options 330 for the data management, data analysis, and other services being provided to the patient. For example, the following GUI designs may be employed singly or in combination, to suit the needs of the user:

Option 1: The GUI provides a simple message informing the physician user that certain analysis functions, such as CGM data analysis, may be covered by insurance. This pop-up may be triggered each time the execution of the interactive software is initiated, when the automatic upload of medical data from the patient is received, or other HCP initiated process.

Option 2: The GUI provides, optionally in addition to a simple message discussed above, a hyperlink or series of hyperlinks that direct the HCP to the reimbursement entity 160 (FIG. 1) or a third party service provider acting therefor, for further information regarding the policies and requirements for reimbursement. Further GUI functions may be implemented to allow the HCP to select from a list of support reimbursement entities from which to retrieve more detailed information on pre-authorization instructions, coding instructions, and contacts for more in-depth resources from each reimbursement entity.

Option 3: The GUI provides a sample “superbill,” which is a form that can be quickly completed and submitted to reimbursement entities for reimbursement that a HCP may use directly or adapt to use in a particular medical practice. The superbill will, as is pertinent to the HCP's practice, contain relevant CPT, HCPCS, and ICD coding, as discussed below: (a) CPT (Common Procedure Terminology) codes must be entered to reflect provision of specific services. Evaluation and Management codes, ICD (International Classification of Diseases) codes, and HCPCS (Healthcare Common Procedure Coding System codes used by Medicare and monitored by CMS (Centers for Medicare and Medicaid Services), may also be required depending on the nature of the coverage applicable to the patient and the provided services. Options for each such code describing its applicability and allowing the field appropriate to the goods and services to be populated will be provided in user-fillable fields, a pop-up window, radio button selections, or the like. Sample codes and a brief description of each that may be provided are given in the below tables:

TABLE 1
Examples of relevant CPT Codes

| CPT Codes | Description |
|---|---|
| Evaluation & | |
| Management Codes | |
| 99211 | For office visits, level 1 to 5 |
| 99212 | For office visits, level 1 to 5 |
| 99213 | For office visits, level 1 to 5 |
| 99214 | For office visits, level 1 to 5 |
| 99215 | For office visits, level 1 to 5 |
| 99354 | For prolonged physician service in the office or |
| | other outpatient setting requiring direct (face- |
| | to-face) patient contact beyond the usual |
| | service; first hour |
| 99355 | Each additional 30 minutes |
| CGM Procedures | |
| 95250 | Ambulatory continuous glucose monitoring of |
| | interstitial tissue fluid via a subcutaneous |
| | sensor for a minimum of 72 hours; sensor |
| | placement, hook-up, calibration of monitor, |
| | patient training, removal of sensor, and |
| | printout of recording |
| 95251 | Ambulatory continuous glucose monitoring of |
| | interstitial tissue fluid via a subcutaneous |
| | sensor for a minimum of 72 hours; |
| | interpretation and report |
| 99091 | Collection and interpretation of physiologic |
| | data (eg, ECG, blood pressure, glucose |
| | monitoring) digitally stored and/or transmitted |
| | by the patient and/or caregiver to the physician |
| | or other qualified health care professional, |
| | requiring a minimum of 30 minutes of time |
| Education Services | |
| Group | |
| 99078 | Physician educational services rendered to |
| | patients in a group setting (eg, prenatal, |
| | obesity, or diabetic instructions) |

TABLE 2
Examples of ICD Codes for Diabetes

| ICD Codes for Diabetes | Description |
|---|---|
| 205 Diabetes mellitus | gestational diabetes (648.8) |
| | hyperglycemia NOS (790.29) |
| | neonatal diabetes mellitus (775.1) |
| | nonclinical diabetes (790.29) |
| | secondary diabetes (249.0-249.9) |
| | The following fifth-digit subsclassification is |
| | for use with category 250: |
| | 0 type II or unspecified type, not stated as |
| | uncontrolled |
| | Fifth-digit 0 is for use for type II patients, even |
| | if the patient required insulin |
| | Use additional code, if applicable, for |
| | associated long-term (current) insulin use |
| | V58.67 |
| | I type I [juvenile type], not stated as |
| | uncontrolled |
| | 2 type II or unspecified type, uncontrolled |
| | Use additional code, if applicable, for |
| | associated long-term (current) insulin use |
| | V58.67 |
| | Fifth-digit 2 is for use for type II, adult-onset, |
| | diabetic patients, even if the patient requires |
| | insulin |
| | 3 type I [juvenile type], uncontrolled |
| 250.0 Diabetes mellitus without mention of | [0-3] |
| complication | Diabetes mellitus without mention of |
| | complication or manifestation classifiable to |
| | 250.1-250.9 |
| | Diabetes (mellitus) NOS |
| 250.1 Diabetes with ketoacidosis | [0-3] |
| | Diabetic: |
| | acidosis without mention of coma |
| | ketosis without mention of coma |
| 250.2 Diabetes with hyperosmolarity | [0-3] |
| | Hyperosmolar (nonketotic) coma |
| 250.3 Diabetes with other coma | [0-3] |
| | Diabetic coma (with ketoacidosis) |
| | Diabetic hypoglycemic coma |
| | Insulin coma NOS |
| | Excludes: |
| | diabetes with hyperosmolar coma (250.2) |
| 250.4 Diabetes with renal manifestations | [0-3] |
| | Use additional code to identify manifestation, |
| | as: |
| | chronic kidney disease (585.1-585.9) |
| | diabetic: |
| | nephropathy NOS (583.81) |
| | nephrosis (581.81) |
| | intercapillary glomerulosclerosis (581.81) |
| | Kimmelstiel-Wilson syndrome (581.81) |
| 250.5 Diabetes with ophthalmic | [0-3] |
| manifestations | Use additional code to identify manifestation, |
| | as: |
| | diabetic: |
| | blindness (369.00-369.9) |
| | cataract (366.41) |
| | glaucoma (365.44) |
| | macular edema (362.07) |
| | retinal edema (362.07) |
| | retinopathy (362.01-362.07) |
| 250.6 Diabetes with neurological | [0-3] |
| manifestations | Use additional code to identify manifestation, |
| | as: |
| | diabetic: |
| | amyotrophy (353.5) |
| | gastroparalysis (536.3) |
| | gastroparesis (536.3) |
| | mononeuropathy (354.0-355.9) |
| | neurogenic arthropathy (713.5) |
| | peripheral autonomic neuropathy (337.1) |
| | polyneuropathy (357.2) |
| 250.7 Diabetes with peripheral circulatory | [0-3] |
| disorders | Use additional code to identify manifestation, |
| | as: |
| | diabetic: |
| | gangrene (785.4) |
| | peripheral angiopathy (443.81) |
| 250.8 Diabetes with other specified | [0-3] |
| manifestations | Diabetic hypoglycemia NOS |
| | Hypoglycemic shock NOS |
| | Use additional code to identify manifestation, |
| | as: |
| | any associated ulceration (707.10-707.9) |
| | diabetic bone changes (731.8) |
| 250.9 Diabetes with unspecified complication | [0-3] |

TABLE 3
Examples of HCPCS Codes

| HCPCS Codes | Description |
|---|---|
| S1030 | Continuous noninvasive glucose monitoring |
| | device, purchase (for physician interpretation |
| | of data, use cpt code) |
| S1031 | Continuous noninvasive glucose monitoring |
| | device, rental, including sensor, sensor |
| | replacement, and download to monitor (for |
| | physician interpretation of data, use cpt code) |
| A9276 | Sensor; invasive (e.g. subcutaneous), |
| | disposable, for use with interstitial continuous |
| | glucose monitoring system, one unit = 1 day |
| | supply |
| A9277 | Transmitter; external, for use with interstitial |
| | continuous glucose monitoring system |
| A9278 | Receiver (monitor); external, for use with |
| | interstitial continuous glucose monitoring |
| | system |

Additional codes suitable to particular medical practices will be known to those of skill in the art and may be adapted for use with a superbill or other reimbursement form provided to a HCP.

Furthermore, the functions to modify the superbill and save it persistently are preferably provided to the HCP to facilitate the adoption of the tool in the medical practice. The superbill may be printed out on paper or electronically to be faxed to the appropriate reimbursement entity 160. Further integration with the reimbursement entity 160 may allow the superbill to be delivered to it from the HCP as electronic billing.

As part of such an electronic billing system, additional lookup functions that clarify the appropriate usage of each code are preferably provided for reference by the HCP; e.g., a compendium of published codes in the CPT Assistant documentation published by the American Medical Association.

Furthermore, data checks to ensure that correct coding has been entered into the superbill or other electronic billing record adapted for use by a particular HCP may also be provided. For example, on their entry, a pop-up window might warn that
“Codes 95250 and 95251 may not be reported more than once per month, and they may not be reported in conjunction with the collection and interpretation of physiologic data code, 99091”
   if the coding entry made does not appear to comply with the rule. In this particular example, the electronic billing system would archive prior records entered for the patient, practice or service rendered, as appropriate, so each new data entry can be checked for internal compliance with reimbursement procedures as well as historical compliance.

Automatic coding updates and management functions are preferably further provided to further facilitate the update of relevant codes that are key to the proper filing of claims since updates to the codes are done periodically. For example, CPT coding is updated periodically, so a service to automatically update the CPT coding data base presented to the HCP with the latest version of the CPT Assistant published by the American Medical Association would be performed.

Option 4: GUI provides, as part of more complete reimbursement support, functions that inform, educate, and support the HCP in helping a patient in obtaining pre-authorization for certain services, such as the use of CGM (continuous glucose monitoring).

The GUI may provide HCP with information concerning additional requirements imposed by private payors and insurance carriers to be carried out before the delivery of services, such as a pre-authorization requirement or diagnostic requirement. For example, some payors require that continuous glucose monitoring (CGM) only be prescribed for patients with type I diabetes, or on diagnostic evidence of recurrent severe hypoglycaemia in the patient. Most preferably, such information is presented on a per-patient and/or per-payor basis, as coverage may differ from different providers based on a particular patient's medical history and deductible payment status.

Pre-authorization procedures may be incorporated as part of a workflow program coded into software provided to the HCP, or as a report integrated with other parts of the HCP computing environment that specifically address a patient intake process. This way, specific information regarding the patient's coverage and reimbursement entity's pre-authorization requirements and procedures are made readily available to the HCP prior to initiating or changing therapy for a particular patient. This pre-authorization procedure is preferably linked to the data analysis functions of the interactive software so that the relevant patient analysis data can be generated automatically and easily provided to payor to justify coverage or reimbursement for the service provided by the HCP.

FIG. 4 is also a flow chart illustrating an embodiment of a method in accordance with aspects of the invention in which patient medical data is managed and reimbursement for this management and treatment are facilitated. An exemplary method of facilitating patient care may comprise implementing health care provider (HCP) software on an HCP computing component 410, operating the interactive HCP software on the computing component 420 when receiving patient medical data, providing a pop-up graphical user interface (GUI) window advising the HCP of reimbursement information or options 430, advising the HCP of reimbursement information or options 440, and optionally, providing the HCP with additional reimbursement resources 450 (discussed below).

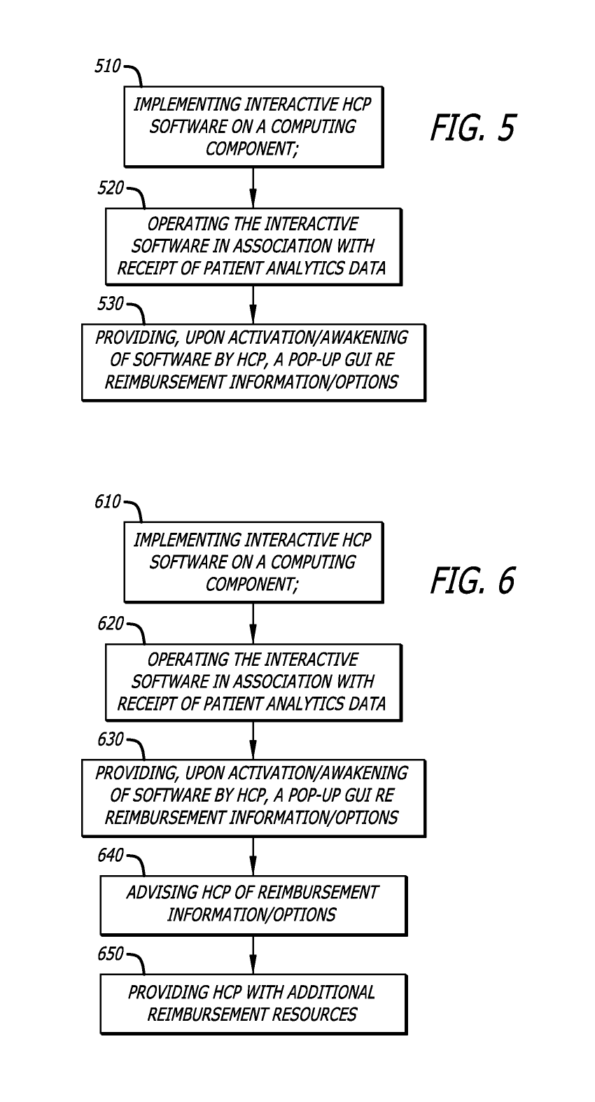

FIG. 5 is a further flow chart illustrating an embodiment of a method in accordance with aspects of the invention in which patient medical data is managed and reimbursement for this management and treatment are facilitated. As shown in FIG. 5, an exemplary method of facilitating patient care may comprise implementing HCP software on a computing component 510, operating an interactive HCP software routine in association with receipt of patient analytics data 520, and providing, when the HCP starts or activates/awakens the interactive HCP software routine, a pop-up graphical user interface (“GUI”) window that advises the HCP of reimbursement information or options 530 (discussed below).

FIG. 6 is a flow chart illustrating yet another embodiment of a method in accordance with aspects of the invention in which patient medical data is managed and reimbursement for this management and treatment are facilitated. As shown in FIG. 6, an exemplary method of facilitating patient care may comprise implementing HCP software on a computing component 610, operating an interactive HCP software routine in association with receipt of patient analytics data 620, and providing, when the HCP starts or activates/awakens the interactive HCP software routine, a pop-up graphical user interface (“GUI”) window that advises the HCP of reimbursement information or options 630, advising the HCP of reimbursement information or options 640, and optionally, providing the HCP with additional reimbursement resources 650 (discussed below).

As described previously, the additional reimbursements resources will preferably include at least potential billing codes for use in communicating the nature of the service provided by the HCP to a patient in connection with analysis of medical data relating to their condition, such as data transmitted from a medical device 140. More particularly, with connectivity to data bases containing patient information as described with respect to FIG. 2, the additional reimbursement resources may be utilized to directly input such codes onto a patient record for archival purposes and/or to populate a billing record for use in billing a healthcare payor, such as a private insurer, Medicare, TriCare, or a state Medicaid service. The resources may also provide information concerning potentially pertinent treatment options (e.g., availability of reimbursable drugs or wellness products), as well as diagnosis menus to assist in selection of an appropriate billing code.

In regard to the term “pop-up window” or “pop-up GUI” used herein, this term is used in a conceptual sense from the viewpoint of the user. Rather than referring to a particular type of window in a graphical user interface known as a pop-up or pop-under or other, it is meant to refer to any new window or display that presents different information to the user from the previous window the user was viewing, regardless of the size of the new window. Whether it is a modal window, child window, pop-up, lightbox, or other, and whether the original page being viewed stays in the background, or disappears, or is grayed-out, the term “pop-up GUI” is meant to include it.

In the present description, the terms component, module, device, etc. may refer to any type of logical or functional process or blocks that may be implemented in a variety of ways. For example, the functions of various blocks can be combined with one another into any other number of modules. Each module can be implemented as a software program stored on a tangible memory (e.g., random access memory, read only memory, CD-ROM memory, hard disk drive) to be read by a central processing unit to implement the functions of the innovations herein. Or, the modules can comprise programming instructions transmitted to a general purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, implementations and features of the invention may be implemented through computer-hardware, software and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe components such as software, systems and methods consistent with the innovations herein may be implemented with any combination of hardware, software and/or firmware. Moreover, the above-noted features and other aspects and principles of the innovations herein may be implemented in various processes and operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used the programs written in accordance with teachings of the invention, or it may be more convenient to construct a specialized apparatus or system to perform the required methods and techniques.

Aspects of the method and system described herein, such as the logic, may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as a data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/nor instructions through wireless, optical, or wired signaling media or any combination thereof. Examples of transfers of such formatted data and/or instructions by carrier waves thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Other implementations of the invention will be apparent to those skilled in the art from consideration of the specification and practice of the invention disclosed herein. It is intended that the specification and examples be considered as exemplary only, with a true scope and spirit of the invention being indicated by the disclosure above in combination with the following paragraphs describing the scope of one or more implementations of the following inventions.

We claim:

1. A method of managing medical data and facilitating reimbursement for data analysis, the method comprising:
selecting a program to process medical data;
automatically enabling a reimbursement display that includes information relating to reimbursement for analysis of medical data; and
selecting the reimbursement display of information and options for viewing.

2. The method of managing medical data and facilitating reimbursement of claim 1, wherein the step of enabling comprises enabling the display in a separate window.

3. The method of managing medical data and facilitating reimbursement of claim 2, wherein the window is interactive.

4. The method of managing medical data and facilitating reimbursement of claim 2, wherein the window provides specific instructions for obtaining reimbursement.

5. The method of managing medical data and facilitating reimbursement of claim 2, wherein the step of selecting the reimbursement display further comprises connecting the reimbursement window to an electronic reimbursement system by which an automated reimbursement process is initiated.

6. The method of managing medical data and facilitating reimbursement of claim 1, wherein the step of enabling comprises automatically enabling a display of reimbursement information and reimbursement options for analysis of processed medical data comprising at least one of:
linking to secondary websites related to reimbursement;
linking to websites containing reimbursement resources;
linking to websites containing a form usable for reimbursement;
linking to a request for obtaining reimbursement;
linking to a web page of a reimbursement entity;
creating a customizable superbill for reimbursement for analysis services;
creating a bill having relevant reimbursement codes;
checking reimbursement codes to confirm correct coding entries;
looking up reimbursement coding usage with a lookup tool;
automatically updating reimbursement codes;
displaying information directed to patient coverage pre-authorization requirement data;
displaying information directed to patient pre-authorization process instructions;
creating a patient coverage pre-authorization request;
displaying information related to evidence needed to justify reimbursement;
displaying information directed to workflow support so that a relevant function is provided in the right stages of serving the patient;
displaying alarms and notices relating to requirements for further information by a reimbursement entity; and
displaying information relating to audit trail records with respect to processing of information for the reimbursement entity.

7. The method of managing medical data and facilitating reimbursement of claim 1, wherein the step of automatically enabling a reimbursement display further comprises automatically enabling the display during operation of a medical data processing program.

8. The method of managing medical data and facilitating reimbursement of claim 1, further comprising uploading medical data, wherein the step of automatically enabling a reimbursement display further comprises automatically enabling the display as part of uploading medical data.

9. The method of managing medical data and facilitating reimbursement of claim 1, further comprising uploading medical data, and installing the reimbursement display from a source of the uploaded medical data.

10. The method of managing medical data and facilitating reimbursement of claim 1, further comprising uploading medical data from a physiological parameter monitor, and installing the reimbursement display from the physiological parameter monitor.

11. The method of managing medical data and facilitating reimbursement of claim 1, wherein the step of automatically enabling a reimbursement display comprises automatically enabling the reimbursement display upon receipt of patient analytics data.

12. The method of managing medical data and facilitating reimbursement of claim 1, wherein the step of automatically enabling a reimbursement display that includes information further comprises enabling a reimbursement display that includes at least one of:
additional reimbursement resources comprising billing codes;
additional reimbursement resources comprising diagnosis menus; and
additional reimbursement resources comprising potential treatment options.

13. A method of managing medical data and facilitating reimbursement for data analysis, the method comprising:
selecting a program to process medical data;
automatically enabling a reimbursement display in a separate interactive window of a GUI when processing medical data, the display including information relating to reimbursement for analysis of medical data and instructions for obtaining reimbursement;
uploading medical data from a physiological parameter monitor;
installing the reimbursement display from the physiological parameter monitor; and
selecting the reimbursement display of information and options for viewing.

14. The method of managing medical data and facilitating reimbursement of claim 13, wherein the step of selecting the reimbursement display further comprises connecting the reimbursement window to an electronic reimbursement system by which an automated reimbursement process is initiated.

15. The method of managing medical data and facilitating reimbursement of claim 13, wherein the step of enabling comprises automatically enabling a display of reimbursement information and reimbursement options for analysis of processed medical data comprising at least one of:
linking to secondary websites related to reimbursement;
linking to websites containing reimbursement resources;
linking to websites containing a form usable for reimbursement;
linking to a request for obtaining reimbursement;
linking to a web page of a reimbursement entity;
creating a customizable superbill for reimbursement for analysis services;
creating a bill having relevant reimbursement codes;
checking reimbursement codes to confirm correct coding entries;
looking up reimbursement coding usage with a lookup tool;
automatically updating reimbursement codes;
displaying information directed to patient coverage pre-authorization requirement data;
displaying information directed to patient pre-authorization process instructions;
creating a patient coverage pre-authorization request;
displaying information related to evidence needed to justify reimbursement;
displaying information directed to workflow support so that a relevant function is provided in the right stages of serving the patient;
displaying alarms and notices relating to requirements for further information by a reimbursement entity; and
displaying information relating to audit trail records with respect to processing of information for the reimbursement entity.

16. A medical data management system to facilitate reimbursement for analysis services on medical data, the analysis performed with a processor and a display, the system comprising:
a medical monitor configured to sense a physiological parameter relevant to a particular disease-afflicted health condition and to provide medical data representative of the sensed parameter; and
a physical medium containing a program configured to program a processor to:
automatically enable a reimbursement display that includes information relating to reimbursement for analysis of the received medical data; and
control a display to present the reimbursement display in a separate window.

17. The medical data management system to facilitate reimbursement for medical data analysis services of claim 16, wherein the program is further configured to program the processor to present in the reimbursement display at least one of:
a link to a secondary website related to reimbursement;
a link to a website containing reimbursement resources;
a link to a website containing a form usable for reimbursement;
a link to a request for obtaining reimbursement;
a link to a web page of a reimbursement entity;
information directed to patient coverage pre-authorization requirement data;
information directed to patient pre-authorization process instructions;
information related to evidence needed to justify reimbursement;
information directed to workflow support so that a relevant function is provided in the right stages of serving the patient;
alarms and notices relating to requirements for further information by a reimbursement entity;
information relating to audit trail records with respect to processing of information for the reimbursement entity;
and is further configured to program the processor to perform at least one of:
create a customizable superbill for reimbursement for analysis services;
create a bill having relevant reimbursement codes;
check reimbursement codes to confirm correct coding entries;
look up reimbursement coding usage with a lookup tool;
automatically update reimbursement codes; and
create a patient coverage pre-authorization request.

18. The medical data management system to facilitate reimbursement for medical data analysis services of claim 16, wherein the program is further configured to program the processor to connect the reimbursement window to an electronic reimbursement system by which an automated reimbursement process is initiated.

19. The medical data management system to facilitate reimbursement for medical data analysis services of claim 16, wherein the program is further configured to program the processor to upload medical data from the medical monitor and install the reimbursement display from the medical monitor.

20. The medical data management system to facilitate reimbursement for medical data analysis services of claim 16, wherein:
the medical monitor comprises a glucose sensor configured to sense a glucose level and to provide glucose level signals; and
the program is further configured to program the processor to receive the glucose level signals, analyze the received glucose level signals, enable the reimbursement display that includes information relating to reimbursement for the analysis, and present the reimbursement display on the display.
